(19) United States
(12) Patent Application Publication
(10) Pub. No.: US 2019/0136770 A1
(43) Pub. Date: May 9, 2019

(54) VALVE ASSEMBLY

(71) Applicant: Volvo Truck Corporation, Göteborg (SE)

(72) Inventors: Bhargav VARANASI, Visakhapatnam (IN); Anantha Rama Krishna Lakshmi Narayana ALLA, Bangalore (IN)

(21) Appl. No.: 16/309,689

(22) PCT Filed: Jun. 16, 2017
(86) PCT No.: PCT/EP2017/064761

§ 371 Date: Dec. 13, 2018

(30) Foreign Application Priority Data
Jun. 20, 2016 (IN) 201641021125

(51) Int. Cl. F02D 33/00; F02M 37/10; F16K 31/30; F02M 37/00; G01F 23/00; G01F 25/00; F02M 37/20; F02D 41/26; B60K 15/03

(52) U.S. Cl. CPC F02D 33/003; F02M 37/10; F16K 31/30; F02M 37/0023; F02M 37/0088; F02D 2041/224; G01F 25/0061; F02M 37/20; F02D 41/26; B60K 15/03; G01F 23/00

(57) ABSTRACT

The present disclosure relates to a valve assembly adapted to be located at least partially in a body of fluid for controlling fluid flow from the body of fluid to a fluid outlet port. The valve assembly has an extension in a first direction and includes a fluid inlet port having an extension at least partially in the first direction. The valve assembly further includes a valve member being movable in the first direction relative to the fluid inlet port between an open position, in which the fluid inlet port is adapted to provide a fluid communication between the body of fluid and the fluid outlet port, and a closed position, in which the valve member covers the fluid inlet port such that fluid communication between the body of fluid and the fluid outlet port via the fluid inlet port is prevented.

### TECHNICAL FIELD

The present disclosure relates to a valve assembly according to the preamble of claim 1. Moreover, the present disclosure relates to a tank assembly, a tank system, a vehicle and/or a method for evaluating the condition of a valve assembly located in a tank.

### BACKGROUND

A vehicle, for instance a heavy-duty vehicle such as a truck, a bus or a construction equipment vehicle, may comprise one or more tanks. For example, a vehicle comprising an internal combustion engine may comprise one or more fuel tanks. Another example of a vehicle is a seagoing vessel such as a ship or a boat.

A fluid consumer, such as an internal combustion engine, may be adapted to receive fluid from a tank. To this end, a fluid pump may be used for feeding fluid from the tank to the fluid consumer. The fluid pump and the fluid consumers are examples of recipients of fluid. In order to reduce the risk that the fluid pump and/or the fluid consumer is fed with air when the tank is empty or almost empty, the tank may comprise a valve assembly being adapted to cut the fluid supply from the tank when the amount of fluid in the tank is low. To this end, a valve may be used that is adapted to be located in a body of fluid and which is adapted to assume an open position or a closed position depending on the fluid level of the body of fluid.

An example of a valve that is adapted to be located in a body of fluid is disclosed in U.S. Pat. No. 3,351,083.

Although the valve assembly according to the above is appropriate for many applications, there may still be a need for improving such a valve assembly.

### SUMMARY

An object of the present disclosure is to provide a valve assembly that can control the supply of fluid to a fluid consumer in a manner that has a low risk of damaging the recipient of the fluid.

As such, the present disclosure relates to a valve assembly adapted to be located at least partially in a body of fluid for controlling fluid flow from the body of fluid to a fluid outlet port of the valve assembly. The valve assembly has an extension in a first direction. The valve assembly comprises a fluid inlet port having an extension at least partially in the first direction. The valve assembly further comprises a valve member being movable in the first direction relative to the fluid inlet port between an open position, in which the fluid inlet port is adapted to provide a fluid communication between the body of fluid and the fluid outlet port, and a closed position, in which the valve member covers the fluid inlet port such that fluid communication between the body of fluid and the fluid outlet port via the fluid inlet port is prevented.

According to the present disclosure, the valve assembly comprises a bleed passage adapted to provide a fluid communication between the body of fluid and the fluid outlet port even when the valve member is in the closed position.

The bleed passage of the valve assembly implies that fluid may be guided from the body of fluid to the fluid outlet port even when the valve member is in its closed position. Thus, a fluid consumer and/or a fluid pump connected to the fluid outlet port of the valve assembly may be supplied with fluid even when fluid is not guided via the fluid inlet port. This in turn implies a reduced risk of damaging the fluid consumer and/or the fluid pump since the risk of a sudden cessation of fluid supply to a running fluid consumer and/or a fluid pump is reduced. Such a sudden cessation could for instance cause dry friction of a fluid pump.

Purely by way of example, the fluid consumer and/or the fluid pump may be adapted to terminate a request of fluid from the body of fluid when the amount of fluid is low. By virtue of the bleed passage, an abrupt termination of the fluid supply may be prevented.

Generally, the body of fluid may comprise, or even be constituted by, a fluid the density of which is greater than the density of air. Purely by way of example, the fluid may be a liquid. As a non-limiting example, the fluid may be fuel, e.g. liquid fuel such as gasoline or diesel.

Optionally, the bleed passage is located upstream the fluid inlet port in an intended direction of flow from the body of fluid to the fluid outlet port. For example, the bleed passage may be such that fluid flowing from the body of fluid to the fluid outlet port passes the fluid inlet port but does not flow there through. As such, the bleed passage need not necessarily form part of a bleed conduit that is separate from the fluid inlet port. Instead, the bleed passage may guide fluid from the body of fluid towards the fluid inlet port.

Optionally, the fluid inlet port is located between the fluid outlet port and the bleed passage in the first direction. As such, when the valve assembly is in a position where the first direction is in parallel with, or forms an angle to, a vertical direction, the bleed passage is located beneath the fluid inlet port in the vertical direction. Thus, even though the valve member has assumed its closed position as a response to the fact that e.g. a tank contains a low amount of fluid, there may still be fluid present at the position of the bleed passage which fluid may be guided to the fluid outlet port via the bleed passage.

Optionally, the valve member is adapted to be imparted a buoyancy force from the body of fluid to thereby be moveable in at least the first direction. The ability to be moveable in response to a buoyancy force implies that the position of the valve member may be controlled by the fluid level of the body of fluid in which the valve assembly is located.

Optionally, the valve member comprises a valve float and a cover member, the cover member being adapted to cover the fluid inlet port when the valve member is in the closed position. The above configuration implies an appropriate way of obtaining a valve member being moveable by means of buoyancy forces.

Optionally, the cover member comprises a circumferentially extending sleeve. A circumferentially extending sleeve implies that appropriate sealing characteristics may be obtained for the fluid inlet port. Moreover, by virtue of the fact that the sleeve is circumferentially extending, it is possible to guide the movement of the cover member in an appropriate manner.

Optionally, the valve assembly comprises a guide arrangement for guiding the cover member relative to the fluid inlet port. The guide arrangement implies that an appropriate movement of the cover member, for instance relative to the fluid inlet port, may be obtained.

Optionally, guide arrangement comprises a plurality of guide members, the fluid inlet port being formed between at least two of the guide members.

Optionally, the valve assembly comprises a collector assembly located beneath the fluid inlet port in the first direction, the collector assembly comprising a fluid receiver adapted to receive fluid from the body of fluid. The collector assembly may accommodate fluid that subsequently may be guided through the bleed passage.

Optionally, the valve member is such that the body of fluid is in fluid communication with the fluid receiver even when the valve member is in the closed position. The above implies that the fluid from the body of fluid may enter the fluid receiver even when the valve member is in its closed position and this in turn implies that fluid may be guided through the bleed passage even when the valve member is in the closed position.

Optionally, the collector assembly comprises a collector base member comprising a first collector base member portion comprising one or more openings, extending at least partially in the first direction, forming the bleed passage.

Optionally, the collector assembly comprises a collector sleeve enclosing the first collector base member portion. The collector base member further comprises a second collector base member portion, located outside of the collector sleeve.

Optionally, the second collector base member portion comprises one or more openings extending at least partially in the first direction. The openings of the second collector base member portion are in fluid communication with the openings of the first collector base member portion.

Optionally, the collector sleeve is connected to the guide arrangement. Preferably the collector sleeve and the guide arrangement form a unitary component.

Optionally, the valve assembly comprises a valve float guide adapted to guide the valve float during a movement in at least the first direction. The possibility to guide the valve float implies an appropriate movement of the valve member.

Optionally, the valve assembly comprises a sensor adapted to determine the position of the valve member in at least the first direction. The position of the valve member may be useful information in many aspects. For instance, the position of the valve member may be indicative of the amount of fluid in a tank.

Optionally, the valve assembly further comprises a filter enclosing the valve member and the fluid inlet port. The filter implies a reduced risk of guiding pollutions to the fluid outlet port.

Optionally, the valve assembly further comprises a main float separated from the valve member. The main float is adapted to assume a fluid presence position indicative of the body of fluid containing sufficient fluid for keeping the valve member in its open position. The main float may be used for determining the status of the valve member. For instance, if the position of the main float indicates that a low fluid level and the position of the valve member indicates a high fluid level, or vice versa, this may imply that the valve member is not operating properly and that service of the valve assembly is required. For instance, such a difference in positions may imply that the valve member is stuck in a fixed position.

Optionally, the valve assembly is adapted to be used in a position where the first direction is in parallel with, or forms an angle to, a vertical direction. Purely by way of example, the first direction may form an angle to the vertical direction wherein the absolute value of the angle is equal to or less than 60°, preferably equal to or less than 40°.

A second aspect of the present disclosure relates to a tank assembly comprising a tank and a valve assembly according to the first aspect of the present disclosure. The valve assembly is located at least partially within the tank.

A third aspect of the present disclosure relates to a tank system comprising a plurality of tank assemblies according to the second aspect of the present disclosure.

A fourth aspect of the present disclosure relates to a vehicle comprising at least one of the following: valve assembly according to the first aspect of the present disclosure, a tank assembly according to the second aspect of the present disclosure and a tank system according to the third aspect of the present disclosure.

A fifth aspect of the present disclosure relates to a method for evaluating the condition of a valve assembly located in a tank. The valve assembly is adapted to control fluid flow from a body of fluid to a fluid outlet port of the valve assembly. The valve assembly comprises a fluid inlet port. The valve assembly further comprises a valve member. The valve member is movable in the first direction relative to the fluid inlet port between an open position, in which the fluid inlet port is adapted to provide a fluid communication between the body of fluid and the fluid outlet port, and a closed position, in which the valve member covers the fluid inlet port such that fluid communication between the body of fluid and the fluid outlet port via the fluid inlet port is prevented.

The tank assembly further comprises a main float separated from the valve member. The main float is adapted to assume a sufficient fluid position in the tank indicative of the tank containing sufficient fluid for keeping the valve member in its open position. The main float is further adapted to assume an insufficient fluid position in the tank indicative of the tank containing insufficient fluid such that the valve member assumes its closed position.

The method comprises:
determining the current position of each one of the main float and the valve member;
upon determination that the main float is in the sufficient fluid position and that the valve member is in its closed position or upon determination that the main float is in the insufficient fluid position and that the valve member is in its open position, issuing a warning signal.

The above method implies that a malfunctioning valve member may be detected in a straightforward manner. For instance, the functionality of a valve member may be assessed without the need for visually inspecting the valve member.

Optionally, the valve assembly is in accordance with the first aspect of the present disclosure.

A sixth aspect of the present disclosure relates to a computer program comprising program code means for performing the steps of the fifth aspect of the present disclosure when the program is run on a computer.

A seventh aspect of the present disclosure relates to a computer readable medium carrying a computer program comprising program code means for performing the steps of the fifth aspect of the present disclosure when the program product is run on a computer.

An eight aspect of the present disclosure relates to a control unit for evaluating the condition of a valve assembly located in a tank. The control unit is configured to perform the steps of the fifth aspect of the present disclosure.

### BRIEF DESCRIPTION OF THE DRAWINGS

With reference to the appended drawings, below follows a more detailed description of embodiments of the invention cited as examples.

In the drawings:

FIG. 1 illustrates a heavy vehicle;

FIG. 2 is a schematic drawing of a tank system;

FIG. 3a is a perspective view of an embodiment of a valve assembly in an open position;

FIG. 3b is a perspective view of the FIG. 3a embodiment in a closed position;

FIG. 4 is a perspective view of a valve member of the FIG. 3a valve assembly;

FIG. 5 and FIG. 6 are perspective views of a guide arrangement and a collector assembly of the FIG. 3a valve assembly;

FIG. 7 is a top side view of the FIG. 3a valve assembly;

FIG. 8 illustrates another embodiment of a valve assembly, and

FIG. 9 illustrates a tank assembly and a flow chart of a method.

It should be noted that the appended drawings are not necessarily drawn to scale and that the dimensions of some features of the present invention may have been exaggerated for the sake of clarity.

### DETAILED DESCRIPTION OF PREFERRED EMBODIMENTS

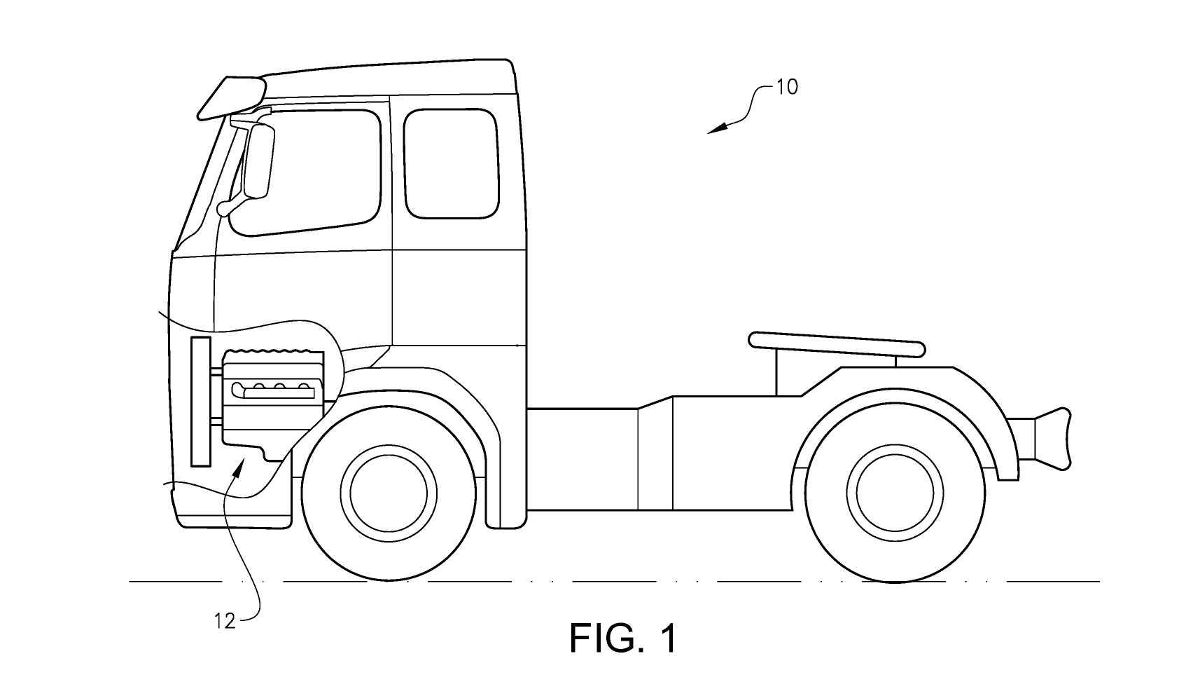

The invention will below be described for a vehicle in the form of a truck 10 such as the one illustrated in FIG. 1. The truck 10 should be seen as an example of a vehicle which could comprise a valve assembly, a tank assembly and/or a tank system according to the present invention. However, the valve assembly, the tank assembly and/or the tank system of the present invention may be implemented in a plurality of different types of objects, e.g. other types of vehicles. Purely by way of example, the valve assembly, the tank assembly and/or the tank system could be implemented in a truck, a tractor, a car, a bus, a seagoing vessel such as a ship or a boat, a work machine such as a wheel loader or an articulated hauler or any other type of construction equipment. The truck 10 comprises an internal combustion engine 12.

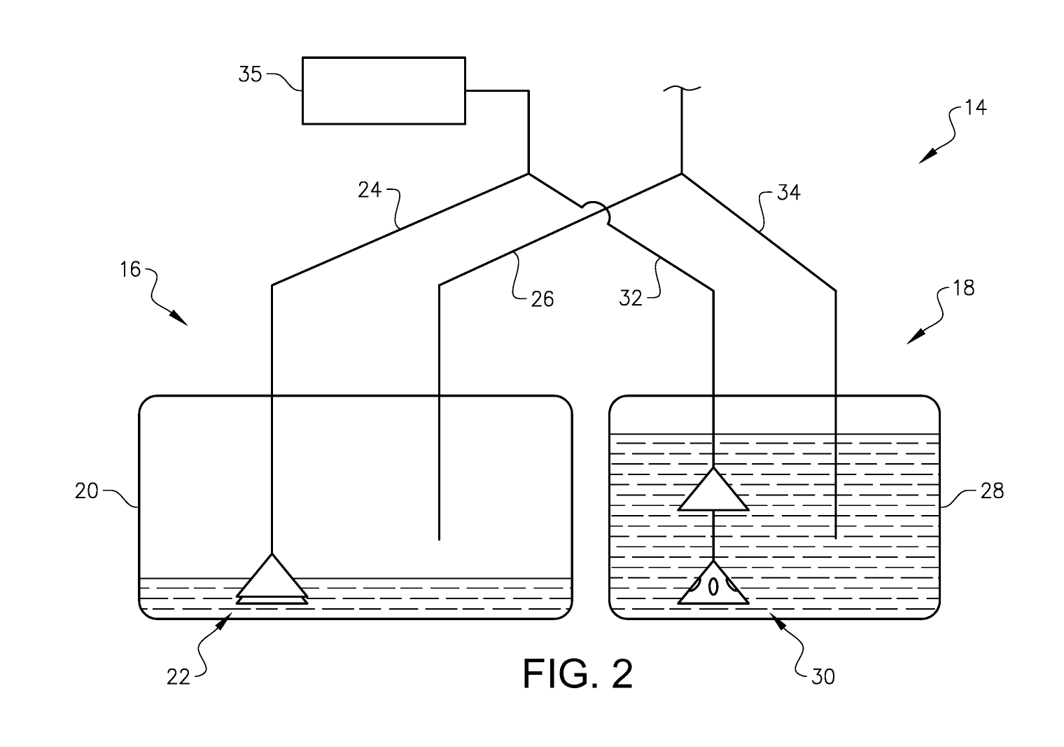

FIG. 2 discloses a tank system 14. For instance, the FIG. 2 tank system can be used in a vehicle 10, such as the vehicle 10 illustrated in FIG. 1. Moreover, as a non-limiting example, the tank system 14 may be a fuel tank system for a vehicle 10.

The FIG. 2 tank system 14 comprises two tank assemblies, viz a master tank assembly 16 and a slave tank assembly 18.

The master tank assembly 16 comprises a master tank 20, a master valve assembly 22, a master fluid feeding conduit 24 and a master fluid return conduit 26. The master valve assembly 22 is located at least partially within the master tank 20. Moreover, the master valve assembly 22 is in fluid communication with the master fluid feeding conduit 24. Further, the master fluid return conduit 26 is adapted to discharge fluid into the master tank 20.

In a similar vein, the slave tank assembly 18 comprises a slave tank 28, a slave valve assembly 30, a slave fluid feeding conduit 32 and a slave fluid return conduit 34. The slave valve assembly 30 is located at least partially within the slave tank 28. Moreover, the slave valve assembly 30 is in fluid communication with the slave fluid feeding conduit 32. Furthermore, the slave fluid return conduit 34 is adapted to discharge fluid into the slave tank 28.

In the FIG. 2 embodiment, the master fluid feeding conduit 24 and the slave fluid feeding conduit 32 are connected to a common fluid pump 35. However, it is also envisioned that, in embodiments of the tank system 14, the master fluid feeding conduit 24 may be connected to one fluid pump and the slave fluid feeding conduit 32 may be connected to another fluid pump (not shown).

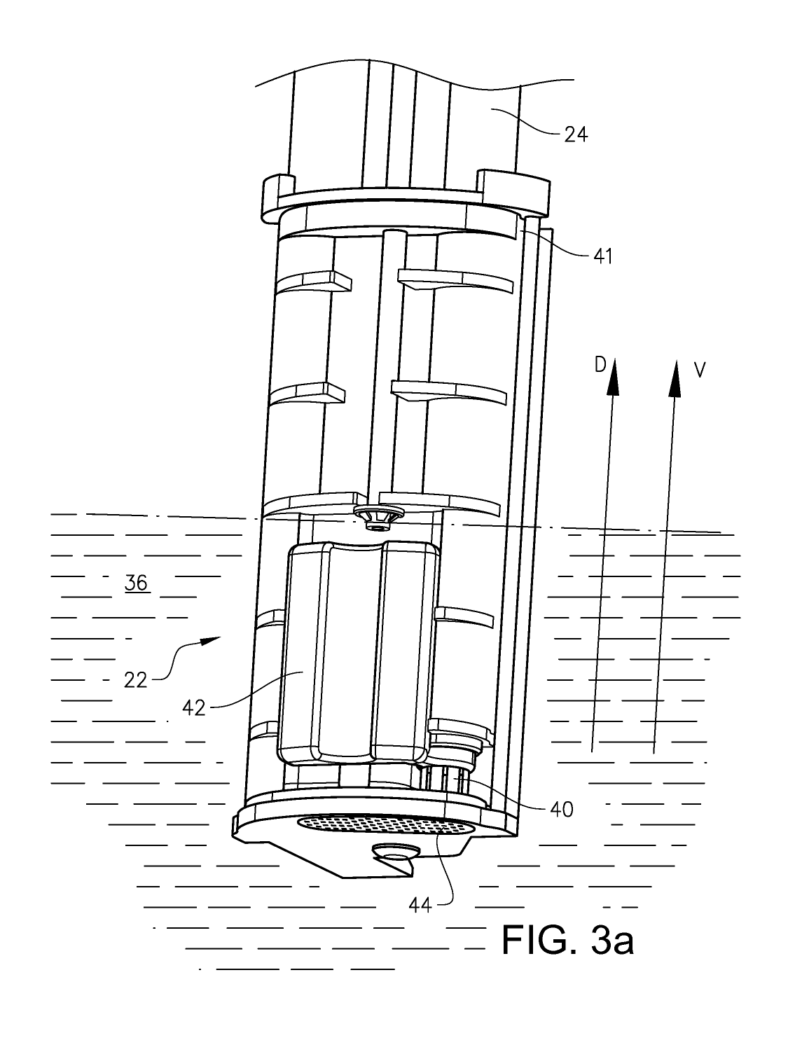

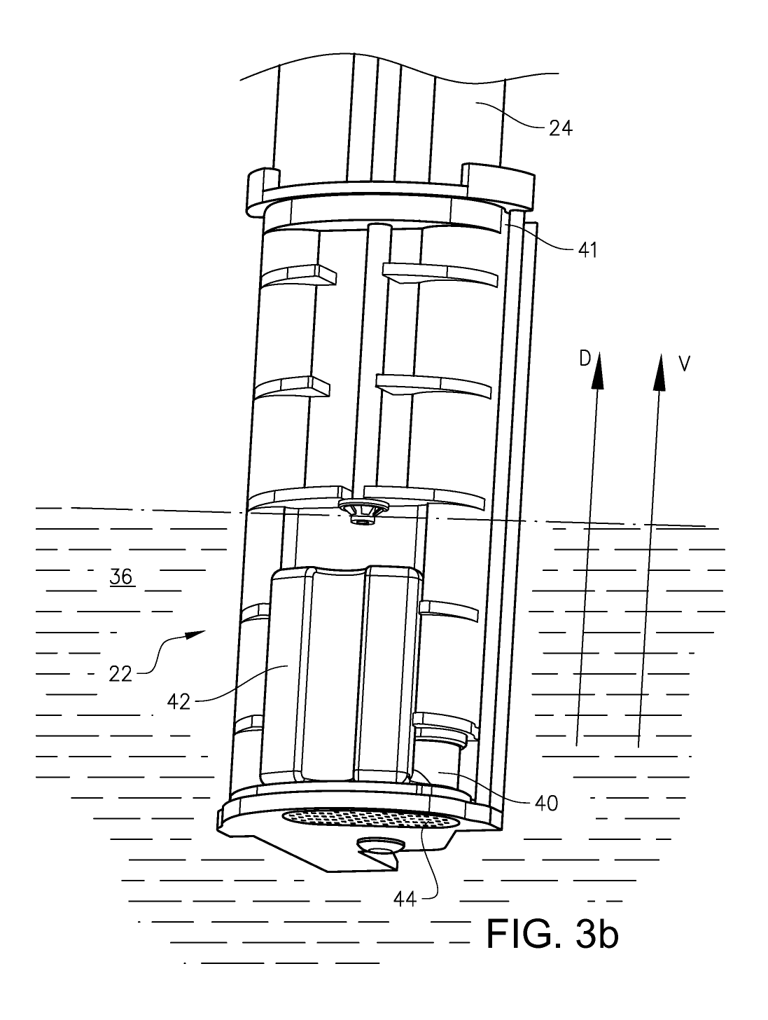

FIG. 3a illustrates an embodiment of a valve assembly 22. For instance, the type of valve assembly 22 illustrated in FIG. 3a may be used for the master valve assembly 22 and/or the slave valve assembly 30 in a tank system such as the FIG. 2 tank system 14.

However, the FIG. 3a assembly may also be used in a tank assembly comprising a single tank (not shown).

The valve assembly 22 is adapted to be located at least partially in a body of fluid 36 for controlling fluid flow from said body of fluid 36 to a fluid outlet port 41 of the valve assembly 22. The fluid outlet port 41 is preferably in fluid communication with a conduit 24 for further transport of the fluid to a recipient of fluid, e.g. to the common fluid pump 35 mentioned hereinabove in relation to FIG. 2.

The FIG. 3a valve assembly 22 is has an extension in a first direction D. Purely by way of example, the valve assembly 22 may be adapted to be used in a position where the first direction D is in parallel with, or forms an angle to, a vertical direction V. Purely by way of example, the first direction D may form an angle to the vertical direction V wherein the absolute value of the angle is equal to or less than 60°, preferably equal to or less than 40°. In the embodiment illustrated in FIG. 3a, the first direction D is in parallel with the vertical direction V.

The valve assembly 22 comprises a fluid inlet port 40 having an extension at least partially in the first direction D. The valve assembly 22 further comprises a valve member 42 being movable in the first direction D relative to the fluid inlet port 40 between an open position, in which the fluid inlet port 40 is adapted to provide a fluid communication between the body of fluid 36 and the fluid outlet port 41, and a closed position, in which the valve member 42 covers the fluid inlet port 40 such that fluid communication between the body of fluid 36 and the fluid outlet port 41 via the fluid inlet port 40 is prevented.

Moreover, as may be gleaned from FIG. 3a, the valve assembly 22 comprises a bleed passage 44 adapted to provide a fluid communication between the body of fluid 36 and the fluid outlet port 41 even when the valve member 42 is in the closed position.

As illustrated in FIG. 3a, the bleed passage 44 may be located upstream the fluid inlet port 40 in an intended direction of flow from the body of fluid 36 to the fluid outlet port 41. Moreover, in the FIG. 3a embodiment, the bleed passage 44 is such that fluid flowing from the body of fluid 36 to the fluid outlet port 41 passes the fluid inlet port 40. Thus, when the valve member 42 is in the closed position, a portion of the valve member 42 at least partially delimits a fluid path from the bleed passage 44 to the fluid outlet port 41 and subsequently to the conduit 24. In FIG. 3a, the fluid inlet port 40 is located between the fluid outlet port 41 and the bleed passage 44 in the first direction D.

The valve member 42 may be implemented in a plurality of ways. However, FIG. 3a illustrates an implementation in which the valve member 42 is adapted to be imparted a buoyancy force from the body of fluid 36 to thereby be moveable in at least the first direction D.

FIG. 3b illustrates the FIG. 3a valve assembly in a condition in which the valve member 42 is in the closed position.

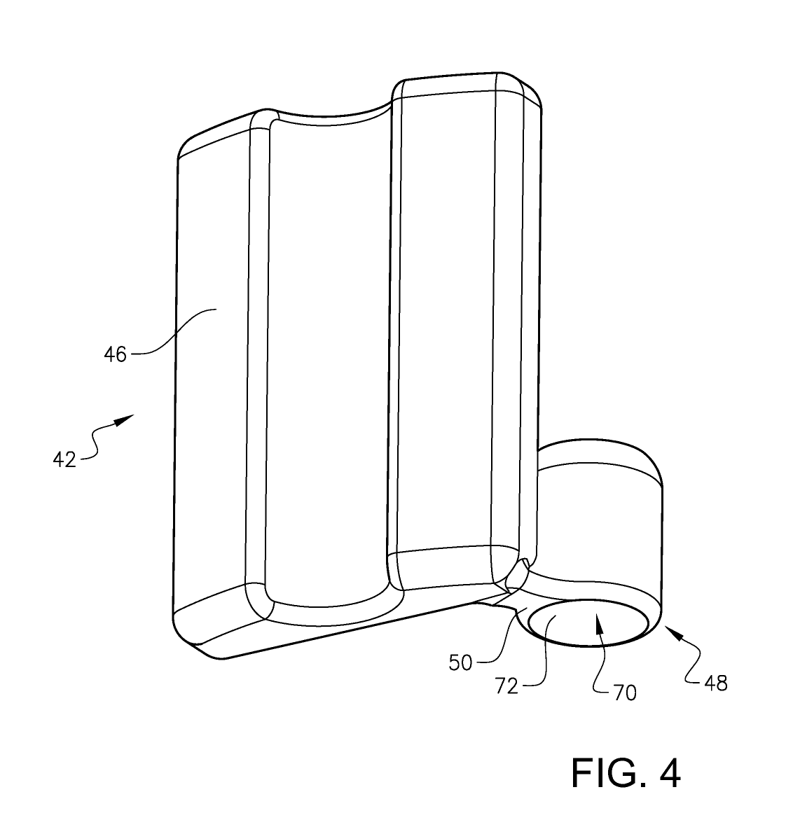

With reference to FIG. 4, a valve member 42 adapted to be imparted a buoyancy force may comprise a valve float 46 and a cover member 48. The cover member 48 is adapted to cover the fluid inlet port 40 when the valve member 42 is in the closed position. The valve float 46 and the cover member 48 may be fixedly connected to one another, for instance via a valve bridging portion 50 as indicated in FIG. 4. However, it is also envisioned that the cover member 48 may be connected directly to the valve float 46. As a non-limiting example, the valve float 46, the cover member 48—and possibly also the valve bridging portion 50 if the valve member 42 comprises such a portion—may form a unitary component.

Moreover, as illustrated in FIG. 4, the cover member 48 may comprise, or even be constituted by, a circumferentially extending sleeve.

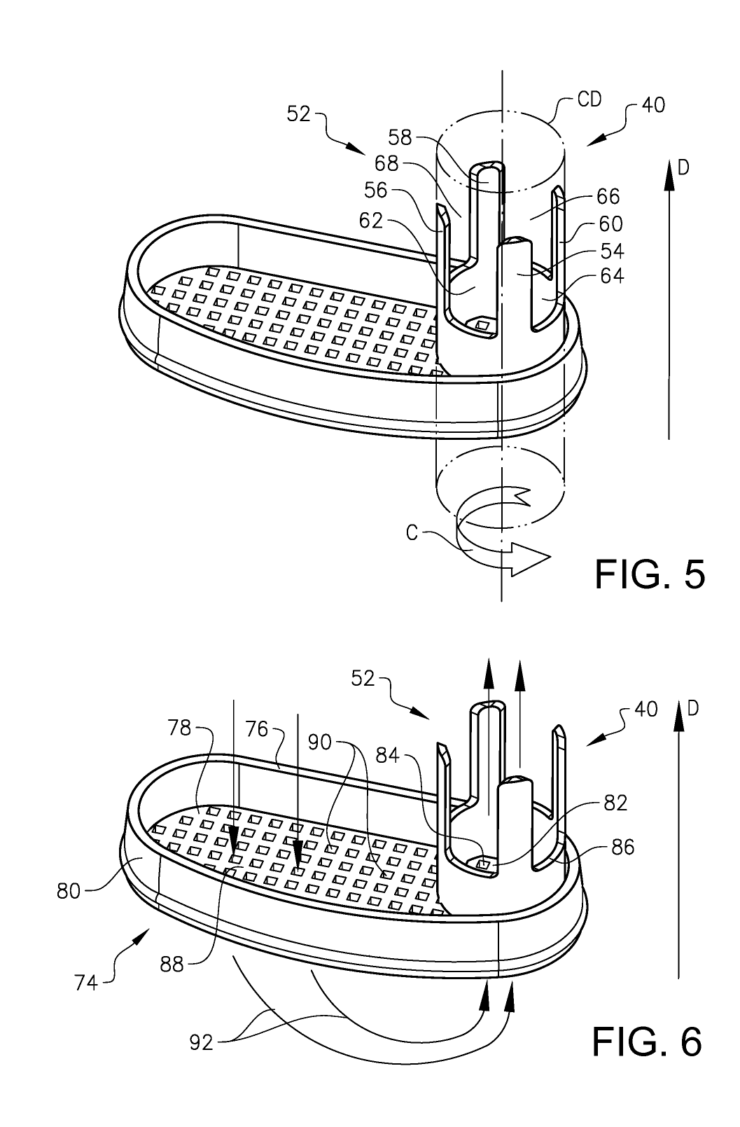

With reference to FIG. 5, the valve assembly may comprise a guide arrangement 52 for guiding the valve member 42 relative to the fluid inlet port. Purely by way of example, and as illustrated in FIG. 5, the guide arrangement 52 may comprise a plurality of guide members 54, 56, 58, 60. Purely by way of example, and as indicated in FIG. 5, the guide members 54, 56, 58, 60 may have an extension in the first direction D as well as in a circumferential direction C. Moreover, in the FIG. 5 embodiment, each one of the guide members 54, 56, 58, 60 may be arranged such that an outer surface of each guide member 54, 56, 58, 60 forms part of an envelop surface of a cylinder CD. However, it is also envisioned that the guide members may be arranged to form any other geometrical structure capable of serving as a guide arrangement.

Moreover, in the FIG. 5 embodiment, the guide members 54, 56, 58, 60 have the same size and are evenly distributed over the envelop surface of the cylinder CD. However, it is also envisioned that implementations of the guide arrangement 52 may comprise guide members 54, 56, 58, 60 having different sizes and/or being unevenly distributed over the envelop surface of the cylinder CD.

The fluid inlet port 40 is formed between at least two of the guide members. In the FIG. 5 embodiment, the fluid inlet port 40 comprises a plurality of port portions 62, 64, 66, 68, each one of which being circumferentially defined by two adjacent guide members 54, 56, 58, 60, as seen in the circumferential direction C.

The FIG. 4 cover member 48, which is a circumferentially extending sleeve, may comprise an internal bore 70, the size and shape of which is adapted to mate with the guide members 54, 56, 58, 60. As such, the internal bore 70 is such that an inner surface 72 of the bore 70 is adapted to contact the outer surface of each one of the guide members 54, 56, 58, 60 when the guide arrangement 52 is inserted into the internal bore 70. By virtue of such a contact, the cover member 48 is guided by the guide members 54, 56, 58, 60 as the cover member 48 moves in the first direction D. Moreover, the contact between the inner surface 72 and each one of the guide members 54, 56, 58, 60 implies that a seal is obtained which reduces, or even prevents, fluid flow to the port portions 62, 64, 66, 68 when the valve member 42 is in the closed position.

However, it is also envisioned that the FIG. 4 cover member 48 may comprise an external envelope surface (not shown) that is adapted to mate with the guide members 54, 56, 58, 60. As such, the external envelope surface may be adapted to contact the radial inside of each one of the guide members 54, 56, 58, 60 when the cover member 48 is inserted into the guide arrangement 52.

FIG. 6 illustrates the same component as FIG. 5. As may be gleaned from FIG. 6, the valve assembly 22 may comprise a collector assembly 74 located beneath the fluid inlet port 40 in the first direction D. The collector assembly comprises a fluid receiver 76 adapted to receive fluid from the body of fluid. Purely by way of example, the collector assembly 74 and the guide arrangement 52 may form a unitary component. As a non-limiting example, such a unitary component may be made of a metal or a plastics material.

The fluid receiver 76 may comprise a collector base member 78 and a rim 80 extending at least partially in the first direction D from the collector base member 78.

As indicated in FIG. 6, the collector base member 78 may comprise a first collector base member portion 82 comprising one or more openings 84, extending at least partially in the first direction D. The one or more openings 84 form the bleed passage 44.

FIG. 5 further illustrates that the collector assembly 74 comprises a collector sleeve 86 enclosing the first collector base member portion 82. The collector base member 78 further comprises a second collector base member portion 88, located outside of the collector sleeve 86. As intimated in FIG. 6, the second collector base member portion 88 may also comprise one or more openings 90 extending at least partially in the first direction D. The openings 90 of the second collector base member portion 88 are in fluid communication with the openings 84 of the first collector base member portion 82. Such a fluid communication is indicated by arrows 92 in FIG. 6. As such, fluid may flow beneath the collector base member 78, as seen in the first direction D, from the second collector base member portion 88 to the first collector base member portion 82.

Moreover, as indicated in FIG. 6, the collector sleeve 86 may be connected to the guide arrangement 52. In fact, in the FIG. 6 implementation, the collector sleeve 86 and the guide arrangement 52 form a unitary component.

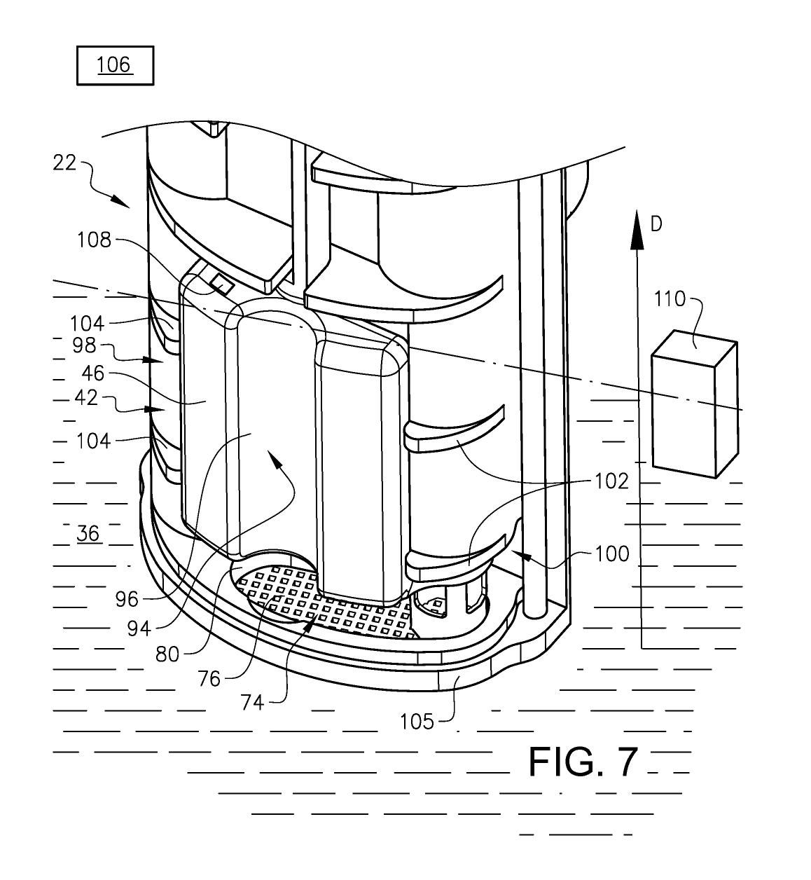

FIG. 7 is a perspective view of the FIG. 3a embodiment of the valve assembly 22. As may be gleaned from FIG. 7, the valve member 42 may be such that the body of fluid 36 is in fluid communication with the fluid receiver 76 of the collector assembly 74 even when the valve member 42 is in the closed position. To this end, and as indicated in FIG. 7, a portion of the valve member 42, such as the valve float 46, may comprise a recess 94 with a recess wall 96. Preferably, the recess wall is such that a projection of the recess wall 96 in the first direction D onto the fluid receiver 76 will have at least a portion that is located within the rim 80.

FIG. 7 further illustrates that the valve assembly 22 comprises a valve float guide 98 adapted to guide the valve float 46 during a movement in at least the first direction D. To this end, the valve assembly 22 may comprise a housing 100 with protrusions 102, 104 each one of which comprising an abutment surface adapted to abut a portion of the valve float 46. Instead of, or in addition to, protrusions, the housing 100 may comprise grooves (not shown) extending at least partially in the first direction D which grooves are adapted to guide the valve float 46.

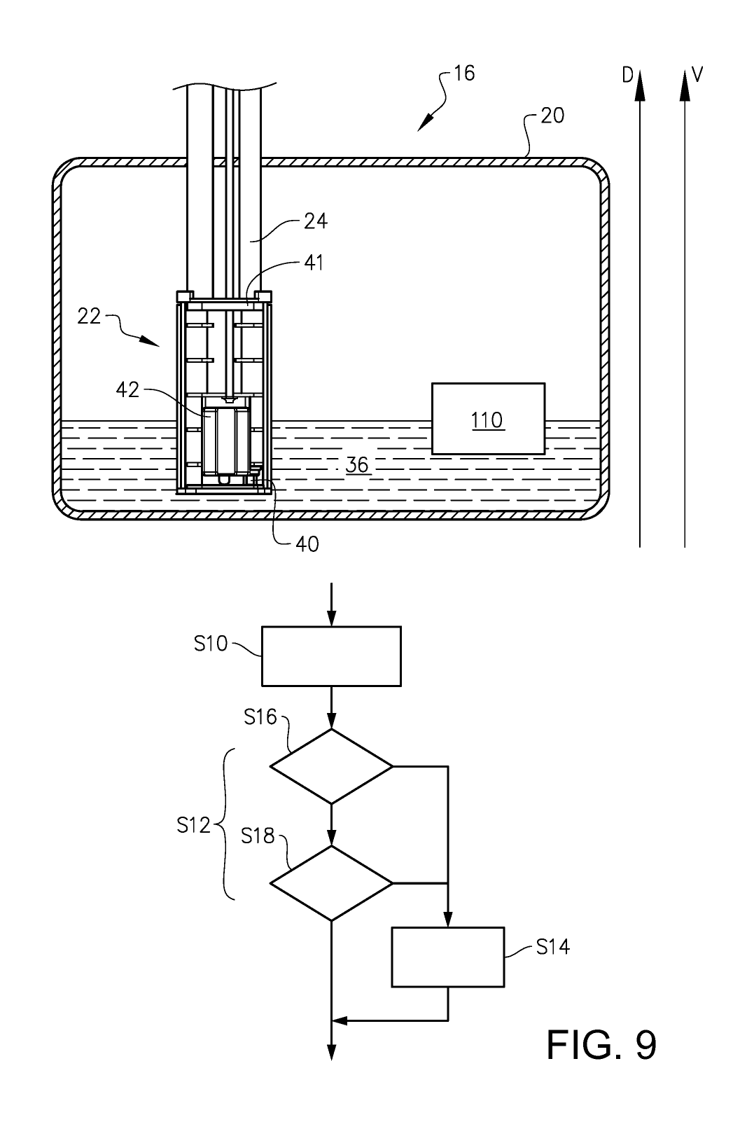

Moreover, the FIG. 7 valve assembly 22 comprises a bottom rim portion 105. Purely by way of example, and as is indicated in FIG. 7, the bottom rim portion 105 may be the lowest portion, as seen in the first direction D, of the valve assembly 22. Moreover, the bottom rim portion 105 may extend circumferentially around the collector assembly 74. Further, as seen in the first direction D, the bottom rim portion 105 may be adapted to be located a small distance, for instance within the range of 0.1-5 millimetres, preferably within the range of 1-3 millimetres, above an inner surface of a tank (not shown) in which the valve assembly 22 is at least partially located. To this end, reference is made to FIG. 9 illustrating an example in which a valve assembly is located in a tank such that a small gap is formed between the bottom rim portion of the valve assembly and the bottom of the tank. By virtue of the bottom rim portion 105, a volume may be formed which is at least partially delimited by the inner surface of the tank and the bottom rim portion 105. Such a volume may allow fluid transport from the openings 90 of the second collector base member portion 88 to the openings 84 of the first collector base member portion 82.

FIG. 7 also illustrates that the valve assembly 22 may comprise a sensor 106 adapted to determine the position of the valve member 42 in at least the first direction D. Purely by way of example, the valve member 42 may comprise a reference portion 108 and the sensor may be adapted to determine the position of the reference portion 108 relative to the fluid inlet port 40. As a non-limiting example, the reference portion 108 may comprise a marker that is identifiable by the sensor 106. For instance, the marker may be a visual or magnetic marker. Purely by way of example, the marker may be an RFID marker.

Moreover, the FIG. 7 embodiment of the valve assembly 22 further comprises a main float 110 separated from the valve member 42. The main float 110 is adapted to assume a fluid presence position indicative of the body of fluid containing sufficient fluid for keeping the valve member 42 in its open position. The main float 110 may be used for determining the status of the valve member 42. This will be elaborated on further hereinbelow.

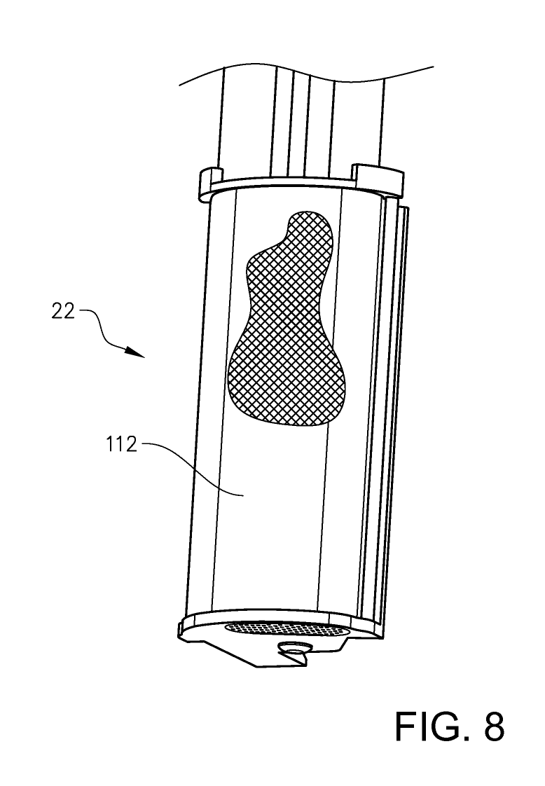

FIG. 8 illustrates an embodiment of the valve assembly 22 which further comprises a filter 112 enclosing the valve member 42 and the fluid inlet port 40.

FIG. 9 illustrates an embodiment of a method of the present invention. The FIG. 9 method is for evaluating the condition of a valve assembly 22 located in a tank 20. The valve assembly 22 is adapted to control fluid flow from a body of fluid 36 to a fluid outlet port 41 which in turn is in fluid communication with a conduit 24.

The valve assembly 22 has an extension in a first direction D, wherein the valve assembly may be adapted to be used in a position where the first direction D is in parallel with, or forming an angle to, a vertical direction V. The valve assembly comprises a fluid inlet port 40. The valve assembly further comprises a valve member 42. The valve member 42 is movable in the first direction D relative to the fluid inlet port 40 between an open position, in which the fluid inlet port 40 is adapted to provide a fluid communication between the body of fluid 36 and the fluid outlet port 41, and a closed position, in which the valve member 42 covers the fluid inlet port 40 such that fluid communication between the body of fluid 36 and the fluid outlet port 41 via the fluid inlet port 40 is prevented. In the embodiment illustrated in FIG. 9, the valve assembly 22 corresponds to the valve assembly that has been presented hereinabove with reference to FIG. 3a. However, the below discussed method may be used for other types of valve assemblies.

The tank assembly 16 further comprises a main float 110 separated from the valve member 42. The main float 110 is adapted to assume a sufficient fluid position in the tank 20 indicative of the tank 20 containing sufficient fluid for keeping the valve member 42 in its open position. The main float 110 is further adapted to assume an insufficient fluid position in the tank 20 indicative of the tank 20 containing insufficient fluid such that the valve member assumes its closed position.

With reference to the flowchart in FIG. 9, the method comprises:

S10: determining the current position of each one of the main float 110 and the valve member 42;

S12: upon determination that the main float 110 is in the sufficient fluid position and that the valve member 42 is in its closed position or upon determination that the main float 110 is in the insufficient fluid position and that the valve member 42 is in its open position,

S14: issuing a warning signal.

As may be realized from FIG. 9, the step S12 may be split into two steps S16, S18. As such, the method may comprise a step S16 of determining if the main float 110 is in the sufficient fluid position and the valve member 42 is in its closed position. Upon determining that the above condition is met, the method proceeds to step S14 and issues a warning signal. In the event that the above condition is not met, the method proceeds to step S18 and determines if the main float 110 is in the insufficient fluid position and the valve member 42 is in its open position. Upon determining that the above condition is met, the method proceeds to step S14 and issues a warning signal.

It is to be understood that the present invention is not limited to the embodiments described above and illustrated in the drawings; rather, the skilled person will recognize that many changes and modifications may be made.

1. A valve assembly adapted to be located at least partially in a body of fluid for controlling fluid flow from said body of fluid to a fluid outlet port of said valve assembly, said valve assembly comprising:
an extension in a first direction,
a fluid inlet port having an extension at least partially in said first direction (D),
a valve member being movable in said first direction relative to said fluid inlet port between an open position, in which said fluid inlet port is adapted to provide a fluid communication between said body of fluid and said fluid outlet port, and a closed position, in which said valve member covers said fluid inlet port such that fluid communication between said body of fluid and said fluid outlet port via said fluid inlet port is prevented, and
a bleed passage adapted to provide a fluid communication between said body of fluid and said fluid outlet port even when said valve member is in said closed position.

2. The valve assembly according to claim 1, wherein said bleed passage is located upstream said fluid inlet port in an intended direction of flow from said body of fluid to said fluid outlet port.

3. The valve assembly according to claim 2, wherein said fluid inlet port is located between said fluid outlet port and said bleed passage in said first direction.

4. The valve assembly according to claim 1, wherein said valve member is adapted to be imparted a buoyancy force from said body of fluid to thereby be moveable in at least said first direction.

5. The valve assembly according to claim 1, wherein said valve member comprises a valve float and a cover member, said cover member being adapted to cover said fluid inlet port when said valve member is in said closed position.

6. The valve assembly according to claim 5, wherein said cover member comprises a circumferentially extending sleeve.

7. The valve assembly according to claim 5, wherein said valve assembly comprises a guide arrangement for guiding said cover member relative to said fluid inlet port.

8. The valve assembly according to claim 7, wherein the guide arrangement comprises a plurality of guide members, said fluid inlet port being formed between at least two of said guide members.

9. The valve assembly according to claim 1, wherein said valve assembly comprises a collector assembly located beneath said fluid inlet port in said first direction, said collector assembly comprising a fluid receiver adapted to receive fluid from said body of fluid.

10. The valve assembly according to claim 9, wherein said valve member is such that said body of fluid is in fluid communication with said fluid receiver even when said valve member is in said closed position.

11. The valve assembly according to claim 9, wherein said collector assembly comprises a collector base member comprising a first collector base member portion comprising one or more openings extending at least partially in said first direction forming said bleed passage.

12. The valve assembly according to claim 11, wherein said collector assembly comprises a collector sleeve enclosing said first collector base member portion, said collector base member further comprising a second collector base member portion, located outside of said collector sleeve.

13. The valve assembly according to claim 12, wherein said second collector base member portion comprises one or more openings extending at least partially in said first direction, said one or more openings of said second collector base member portion being in fluid communication with said one or more openings of said first collector base member portion.

14. The valve assembly according to claim 12, wherein said valve assembly comprises a guide arrangement for guiding said cover member relative to said fluid inlet port, and wherein said collector sleeve is connected to said guide arrangement, preferably said collector sleeve and said guide arrangement forming a unitary component.

15. The valve assembly according to claim 5, wherein said valve assembly comprises a valve float guide adapted to guide said valve float during a movement in at least said first direction.

16. The valve assembly according to claim 1, wherein said valve assembly comprises a sensor adapted to determine the position of said valve member in at least said first direction.

17. The valve assembly according to claim 1, wherein said valve assembly further comprises a filter enclosing said valve member and said fluid inlet port.

18. The valve assembly according to claim 1, wherein said valve assembly further comprises a main float separated from said valve member, said main float being adapted to assume a fluid presence position indicative of said body of fluid containing sufficient fluid for keeping said valve member in its open position.

19. The valve assembly according to claim 1, wherein said valve assembly is adapted to be used in a position where the first direction is in parallel with, or forms an angle to, a vertical direction, wherein the absolute value of the angle is equal to or less than 60°.

20. A tank assembly comprising a tank and a valve assembly according to claim 1, said valve assembly being located at least partially within said tank.

21. A tank system comprising a plurality of tank assemblies according to claim 20.

22. A vehicle comprising a valve assembly according to claim 1.

23. A method for evaluating the condition of a valve assembly located in a tank, said valve assembly being adapted to control fluid flow from a body of fluid to a fluid outlet port of said valve assembly, said valve assembly having an extension in a first direction, said valve assembly comprising a fluid inlet port, said valve assembly further comprising a valve member, said valve member being movable in said first direction relative to said fluid inlet port between an open position, in which said fluid inlet port is adapted to provide a fluid communication between said body of fluid and said fluid outlet port, and a closed position, in which said valve member covers said fluid inlet port such that fluid communication between said body of fluid and said fluid outlet port via said fluid inlet port is prevented, said tank assembly further comprising a main float separated from said valve member, said main float being adapted to assume a sufficient fluid position in said tank indicative of the tank containing sufficient fluid for keeping said valve member in its open position, said main float further being adapted to assume an insufficient fluid position in said tank indicative of the tank containing insufficient fluid such that said valve member assumes its closed position, said method comprising:
determining the current position of each one of said main float and said valve member; and
upon determination that said main float is in said sufficient fluid position and that said valve member is in its closed position or upon determination that said main float is in said insufficient fluid position and that said valve member is in its open position, issuing a warning signal.

24. The method according to claim 23, wherein said valve assembly comprises a bleed passage adapted to provide a fluid communication between said body of fluid and said fluid outlet port even when said valve member is in said closed position.

25. (canceled)

26. A non-transitory computer readable medium carrying a computer program comprising computer readable program instructions for performing the operations of claim 23 when said program instructions are executed by a computer.

27. A control unit for evaluating the condition of a valve assembly located in a tank, the control unit being configured to perform the operations of claim 23.
